(19) United States
(12) Patent Application Publication
(10) Pub. No.: US 2007/0049657 A1
(43) Pub. Date: Mar. 1, 2007

(54) Antiskinning compound and compositions containing them

(76) Inventors: Nicholas M. Martyak, Bucks County, PA (US); Daniel Alford, Montgomery County, PA (US)

Correspondence Address: ARKEMA INC.;PATENT DEPARTMENT - 26TH FLOOR, 2000 MARKET STREET, PHILADELPHIA, PA, 19103-3222, US

(21) Appl. No.: 11/209,459

(22) Filed: Aug. 23, 2005

(51) Int. Cl. C03C 17/00

(52) U.S. Cl. 523/160; 106/310

(57) ABSTRACT

The invention relates to isoascorbate anti-skinning agents and also relates to oxidatively drying paints or coating compositions containing isoascorbate material which acts as both an antiskinning agent and a metals dryer co-promoter.

### FIELD OF THE INVENTION

The invention relates to an anti-skinning agent, coating compositions containing the anti-skinning agent and articles coated with such compositions. The anti-skinning agent is an isoascorbate material. The invention further relates to compositions containing these anti-skinning agent(s), like coating compositions such as oxidatively drying alkyd resins.

### BACKGROUND OF THE INVENTION

Colorless and pigmented oxidatively drying paints and coatings based on oxidatively drying oils, alkyd resins, epoxy esters and other oxidatively drying refined oils are known. These oils and binders crosslink oxidatively under the influence of oxygen (preferably atmospheric oxygen) by means of the addition of driers, such as metal carboxylates of transition metals. If this crosslinking takes place before the product is actually used, they can form a solid barrier film, a skin, on the surface when stored in open or closed containers. This is highly undesirable and should therefore be avoided since it makes the paint more difficult to work with, and commonly interferes with the uniform distribution of the driers. The accumulation of the driers in the paint skin that forms can lead to considerable delays in the drying of the paint when it is applied.

Skinning of the paint film after application is also disadvantageous. Excessively rapid drying of the surface of the paint prevents the lower film layers from drying evenly because they are shielded from oxygen, which is prevented from sufficiently penetrating into and dispersing within the paint film. This can lead among other things to flow problems in the paint film, adhesion problems, or insufficiently hard films.

It is known to add organic substances to a paint that inhibit the reaction of the drier with (atmospheric) oxygen by binding the oxygen or by complexing of the drier metal.

U.S. Pat. No. 4,618,371 describes the use of aliphatic α-hydroxy ketones as anti-skinning agents. DE-A 1 519 103 discloses N,N-dialkylated hydroxylamines for this purpose. Because of their low volatility, however, hydroxylamines alone can lead to severe delays in drying and often also to reduced film hardness values, so that their possible applications are limited. They have not been able to gain commercial acceptance as anti-skinning agents. U.S. Pat. No. 6,730,157 describes the use of organic hydroxylamines such as diethylhydroxylamine and β-dicarbonyl compounds such as diethylformamide as anti-skinning agents. U.S. patent application publication 2003/0047112 discloses a mixture of an aliphatic amine and/or its salt with a compound of the formula specified therein, such as diethyl formamide as an antiskinning additive for lacquer systems. U.S. Pat. No. 6,224,659 discloses the use of a combination of tin compounds as antiskinning agents for oxidatively drying binders.

A central issue in alkyd resin technology is to thoroughly cure the resin, which occurs via oxidative crosslinking, while maintaining adequate anti-skinning properties. Antiskinning requires slowing the curing reaction at the air-resin interface. Oximes, which act as oxygen scavengers, or suitable phenolic compounds are most often used today as anti-skinning agents in industry. However, the phenolic anti-skinning agents display a significant delay in surface drying such that alone they are only suitable for certain coating compositions. Oximes such as e.g. methyl ethyl ketoxime (MEKO) or butyraldoxime, on the other hand, display only slight delays in surface drying due to their volatility. The high volatility of oximes results in rapid loss of this anti-skin agent from the alkyd and thus does not adequately control skinning. The most significant disadvantage of the oximes, which are widely used today, lies in their toxicity. As a consequence of this, users have to observe elaborate personal protection precautions when working with paints containing oximes as anti-skinning agents.

Drying of such coatings involves the competing issues of controlling oxidative drying of the surface and desirable oxidative drying throughout the coating.

Typical prior art treatments employed two components to allow a “balancing” of these competing issues. It was discovered that the use of the single compound, an isoascorbate material, can provide both oxygen scavenging to control surface skinning while complexing with metal, such as cobalt, based dryers to enhance dry through. The use of an amine based oxygen scavenger such as MEKO or DEHA is not needed and the need for a secondary additive such as an amine compound to “activate” a metal dryer is also eliminated. The present invention provides a simplified, single component treatment for oxidatively dried coatings which incorporate a cobalt based dryer.

Incorporating the single, isoascorbate material antiskinning treatment according to the present invention into an air-drying alkyd resin incorporating a metal based dryer provides an alkyd resin system which is resistant to undesirable skinning and exhibits acceptable drying of the resin films after application.

### DETAILED DESCRIPTION OF THE INVENTION

The present invention relates to an isoascorbate material anti-skinning agent. Isoascorbate material as used herein refers to any isoascorbate including but not limited to isoascorbic acids (sometimes called erythorbic acid) and salts thereof such as sodium isoascorbate monohydrate. It was found that the isoascorbate material anti-skinning agent provides effective antiskinning control and complexes with metals such as cobalt. This dual activity provides skinning control along with acceptable dry through without the need for an additional additive such as a co-promoter or drier activator. This invention provides a single additive that provides for effective control of both processes. The control of skinning, that is the drying at the air-resin interface and the control of dry through or the drying of the entire resin coating are both of concern in resin coating formulation. The single, isoascorbate material additive of the present invention provides for control of both properties thus limiting the materials added to the resin base.

The invention also relates to compositions of matter such as coating materials, paints or finishes containing these anti-skinning agents.

For use according to the present invention the isoascorbate material can be in pure form or in aqueous solution or aqueous dispersion or emulsion or in the form of solutions in organic solvents. Aqueous in this context is intended to mean that water is either the sole solvent or is added in a quantity of over 50 wt. % relative to the solvent blend together with conventional organic solvents (e.g. alcohols).

The amount of isoascorbate material anti-skinning agent used in a coating system primarily depends on the content of binder and drier used in the particular coating composition. As a general rule between about 0.001 and 2.0 wt. % of isoascorbate anti-skinning agent according to the present invention should be added. Preferred amounts to be used are about 0.01 to 0.5 wt. %, relative in each case to the overall composition of the coating composition. The amounts can also depend on the type of binder and the pigments used in the coating composition. Thus, in special systems the relative amount of additive to be used can also be greater than about 2.0 wt. % (relative to the overall composition).

It is an advantage of the isoascorbate material anti-skinning agent of the present invention that it reliably prevents skinning in a wide range of binders and when used with various driers but that it does not unfavorably influence other drying properties of the resin.

The invention is further illustrated but is not intended to be limited by the following examples in which all parts and percentages are by weight unless otherwise specified.

### EXAMPLES

### Example 1

The oxygen scavenging capabilities of isoascorbic acid vs. MEKO were evaluated. Aqueous solutions were made containing ˜1×10⁻³ M of either isoascorbic acid or MEKO. The solutions were adjusted to pH 9.0 with dilute sulfuric acid or sodium hydroxide and the removal of oxygen from an aqueous solution was monitored using an O₂-sensitive electrode. The results show isoascorbic acid is effective in scavenging dissolved oxygen (DO), reducing the initial concentration to approximately one-half of its original concentration in less than about 20 minutes. MEKO is slow to reduce the DO from its original concentration. Table 1 summarizes the results.

TABLE 1

| | |
|---|---|
| Isoascorbic acid | MEKO |

| Time (min) | O₂ (ppm) | Time (min) | O₂ (ppm) |
|---|---|---|---|
| 1 | 8.35 | 1 | 8.71 |
| 2 | 7.64 | 2 | 8.41 |
| 3 | 7.22 | 3 | 8.28 |
| 4 | 6.89 | 4 | 8.20 |
| 5 | 6.62 | 5 | 8.15 |
| 6 | 6.39 | 6 | 8.13 |
| 7 | 6.19 | 7 | 8.11 |
| 8 | 6.00 | 8 | 8.09 |
| 9 | 5.83 | 9 | 8.08 |
| 10 | 5.68 | 10 | 8.06 |
| 15 | 5.11 | 15 | 8.03 |
| 20 | 4.77 | 20 | 8.02 |
| 25 | 4.58 | 25 | 8.01 |
| 30 | 4.50 | 30 | 8.00 |
| 60 | 4.49 | 60 | 8.03 |
| 90 | 4.66 | 90 | 8.10 |

### Example b 2

To test the activity of isoascorbic acid in complexing Co(ll) in addition to scavenging oxygen, tung oil was used as the curing medium. When cobaltous, Co(ll), is added to tung oil it quickly causes curing, loss of cis unsaturation in the oil producing a hard film. Addition of an anti-skin agent(s) slows the curing of tung oil.

Curing of Tung Oil Only: to a 100 gram sample of tung oil was added 0.1% by weight of Co(ll) (0.83 grams of Co 12 available from OMG America, Westlake, OH). The cobalt was adequately mixed into the tung oil.

Concentrated anti-skin agent(s) solutions as described below were prepared in water then added to tung oil (No amines were added to act as co-promoters):

Sample A. No Co(ll) or Antiskin Agent: A 10 gram sample of tung oil was placed in a glass bottle. The bottle was placed in an exhaust hood with air flowing over the top of the glass bottle at the rate of approximately 100 ft³/minute.

Sample B. No Antiskin Agent: A 10 gram sample of tung oil-Co(ll) was placed in a glass bottle. The bottle was placed in an exhaust hood with air flowing over the top of the glass bottle at the rate of approximately 100 ft³/minute.

An equimolar solution of Co(ll) and isoascorbic acid was prepared from 4.15 grams of a 1% Co(ll) solution and 3.5 grams of isoascorbate. This Co(ll):Isoascorbic acid solution was used in preparing the following samples.

Sample C. Equimolar Co(ll):Isoascorbate: A 9 gram sample of tung oil was placed in a glass bottle and 1 gram of the Co(ll):Isoascorbic acid solution was added. The solution is adequately mixed and the bottle placed in an exhaust hood with air flowing over the top of the glass bottle at the rate of approximately 100 ft³/minute.

Sample D. 200 ppm Additional Sodium Isoascorbate: A 9 gram sample of tung oil was placed in a glass bottle and 1 gram of the Co(ll):Isoascorbic acid solution along with an additional 2 mg (200 ppm) of sodium isoascorbate [9.3×10-6 M]. The solution was adequately mixed and the bottle placed in an exhaust hood with air flowing over the top of the glass bottle at the rate of approximately 100 ft³/minute.

Sample E. 500 ppm Additional Sodium Isoascorbate: A 9 gram sample of tung oil was placed in a glass bottle and 1 gram of the Co(ll):Isoascorbic acid solution along with an additional 5 mg (500 ppm) of sodium isoascorbate [2.3×10-5 M]. The solution was adequately mixed and the bottle placed in an exhaust hood with air flowing over the top of the glass bottle at the rate of approximately 100 ft³/minute.

The samples were observed over time for the formation of skin formation at the air-sample interface. Table 2 summarizes the results.

TABLE 2

| | | | | Sample D | Sample E |
|---|---|---|---|---|---|
| | Sample A | Sample B | Sample C | Co(II)- | Co(II)- |
| | No Co; No | Co(II) Only; | Eqi-Molar | Isoascorbate + | Isoascorbate + |
| | Anti-Skin | No Anti-Skin | Co(II)- | 200 ppm | 500 ppm |
| Solution/Days | Additive | Additive | Isoascorbate | Isoascorbate | Isoascorbate |
| 0 | No Skinning | No Skinning | No Skinning | No Skinning | No Skinning |
| 1 | No Skinning | Skinning | No Skinning | No Skinning | No Skinning |
| 2 | No Skinning | Skinning | No Skinning | No Skinning | No Skinning |
| 3 | No Skinning | Skinning | Starting to Skin | No Skinning | No Skinning |
| 4 | No Skinning | Skinning | Skinning | No Skinning | No Skinning |
| 5 | No Skinning | Skinning | Skinning | Starting to | No Skinning |
| | | | | Skin | |
| 6 | No Skinning | Skinning | Skinning | Skinning | Starting to |
| | | | | | Skin |
| 7 | No Skinning | Skinning | Skinning | Skinning | Skinning |
| 8 | No Skinning | Skinning | Skinning | Skinning | Skinning |
| 9 | No Skinning | Skinning | Skinning | Skinning | Skinning |
| 10 | No Skinning | Skinning | Skinning | Skinning | Skinning |
| 11 | No Skinning | Skinning | Skinning | Skinning | Skinning |

The data shows that isoascorbic acid slows skinning and also modulates the activity of Co(ll).

While the present invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

1. A coating material, paint or finish which contains an oxidatively drying film former and, as an antiskinning agent isoascorbate material.

2. The coating material, paint or finish of claim 1, wherein said isoascorbate material is selected from isoascorbic acid, salts thereof or mixtures thereof.

3. The coating material, paint or finish of claim 1, which contains the said isoascorbate in an amount of from 0.001 to 2% by weight, based on the total surface coating.

4. The coating material, paint or finish of claim 1, which contains an alkyd resin as the oxidatively drying film former.

5. A process for the production of a coating material, paint or finish containing an oxidatively drying film former comprising incorporating into the coating material, paint or finish, an antiskinning agent comprising isoascorbate.

6. The coating material, paint or finish of claim 1, further comprising a metal selected from groups 1A, 2A, 3A, 4A, 5A, 1B, 2B, 3B, 4B, 5B, 6B, 7B and 8B of the periodic table or combinations thereof.

7. The coating material, paint or finish of claim 6, wherein said metal is cobalt.

8. The coating material, paint or finish of claim 6, wherein said metal is manganese.

9. A process for the production of a coating material, paint or finish containing an oxidatively drying film former comprising incorporating into the coating material, paint or finish, an antiskinning agent comprising an isoascorbate material.

10. The process of claim 9, wherein said isoascorbate material is selected from isoascorbic acid, salts thereof or mixtures thereof.

11. The process of claim 9, which contains the said isoascorbate in an amount of from 0.001 to 2% by weight, based on the total surface coating.

12. The process of claim 9, wherein said oxidatively drying film former is an alkyd resin.

13. The process of claim 9, further comprising a metal selected from groups 1A, 2A, 3A, 4A, 5A, 1B, 2B, 3B, 4B, 5B, 6B, 7B and 8B of the periodic table or combinations thereof.

14. The process of claim 13, wherein said metal is cobalt.

15. The process of claim 13, wherein said metal is manganese.

16. The process of claim 5, wherein said isoascorbate material is selected from isoascorbic acid, salts thereof or mixtures thereof.

17. The process of claim 5, which contains the said isoascorbate in an amount of from 0.001 to 2% by weight, based on the total surface coating.

18. The process of claim 5, wherein said oxidatively drying film former is an alkyd resin.

19. The process of claim 5, further comprising a metal selected from groups 1A, 2A, 3A, 4A, 5A, 1B, 2B, 3B, 4B, 5B, 6B, 7B and 8B of the periodic table or combinations thereof.

20. The process of claim 19, wherein said metal is cobalt.

21. The process of claim 19, wherein said metal is manganese.
